(19) United States
(12) Patent Application Publication
(10) Pub. No.: US 2021/0378256 A1
(43) Pub. Date: Dec. 9, 2021

(54) CHOCOLATE CONSISTING OF PROPOLIS EXTRACT AND A METHOD FOR ITS PRODUCTION

(71) Applicant: SBS BILIMSEL BIO ÇÖZÜMLER SANAYI VE TICARET A.S., Istanbul (TR)

(72) Inventors: Asli Elif TANUGUR SAMANCI, Istanbul (TR); Taylan SAMANCI, Istanbul (TR)

(21) Appl. No.: 17/281,128

(22) PCT Filed: May 22, 2019
(86) PCT No.: PCT/TR2019/050360

§ 371 Date: Mar. 29, 2021

(30) Foreign Application Priority Data
Oct. 12, 2018 (TR) 2018/15178

(51) Int. Cl. A23G 1/40; A23G 1/42; A23G 1/48; A23L 3/3472; A23G 1/46; A23G 1/54

(52) U.S. Cl. CPC A23G 1/40; A23G 1/42; A23G 1/545; A23L 3/3472; A23G 1/46; A23G 1/48

(57) ABSTRACT

A food product containing propolis extract in both inner and outer fillings for use in the food industry, wherein it is a chocolate or similar food product having raw honey and propolis, as sweetener and preservative, respectively, in the inner and outer fillings.

### THE RELATED ART

The present disclosure relates to a chocolate and similar products containing propolis extract sweetener compound instead of refined sugar for use in food sector and a method for production of such products.

The present disclosure relates to a chocolate and similar food products containing raw honey as sweetener and propolis extract as a preservative in both inner and outer fillings of sweet food products and a method for producing such products.

### BACKGROUND OF THE INVENTION

Chocolate is a food product prepared by mixing cacao mass and cacao oil made from beans of the tropical cacao tree with sweetener, milk fat, additive and/or aroma. These ingredients can be either in solid or liquid form depending on their attributes. Moisture contents of the compounds used therein are considered crucial for final product quality and shelf life. Compounds with high moisture content affect both the taste and the shelf life of the final product negatively. Therefore, ingredients containing water such as honey can only be used in minimal amounts or in dried powder form in the formulations of chocolate and chocolate-based products. However, in such case, antioxidant agents and antifungal and antiviral agents contained in honey are also limited in such products.

Propolis is a nutritional food presenting antiviral, antibacterial, and antioxidant features. Bees produce it through the action of some natural enzymes on a paste made from chewing of various plants and trees. However, its bitter taste limits its use in food products considerably.

Nowadays, the chocolate production involves the steps of cleaning and roasting of cacao beans and grinding the cacao nibs following a separation process to obtain cacao mass. Roasted cacao particles are mixed with sugar and turned into a paste form by heavy rollers, where cacao oil is added to soften the mixture. This mixture is thinned and sent to kneading machines, called conche, where aroma extracts and additives are added. After the addition of such agents, the mixture is annealed by a controlled cooling and heating method, and liquid chocolate is obtained. In the end, the liquid chocolate is poured into molds or coated over the product and following its cooling the desired chocolate product is obtained.

Patent document numbered TR200908388 is an example for a known-technique situation. This document explains a dry honey-powder production method for the food industry that is suitable for use in products such as chocolate and prepared by mixing of specific agents at certain amounts. A spray drier or a drum drier is used in the production of honey powder with the addition of maltodextrin and silicon dioxide in appropriate ratios. However, maltodextrine and silicone dioxide used as drying agent may cause aggregation during production as well as has taste and aroma that may influence end product quality negatively.

Because of the inadequacy of the related art, it has become necessary to develop a product, without limiting raw honey's antioxidant and antifungal characteristics, that can be added in a form other than powder into other products, with the propolis extract, and a method for production of it. The present invention is a chocolate mixture consisting of a propolis extract and a method for production of it.

### PURPOSE OF THE INVENTION

The present invention is related to a chocolate product consisting of raw honey and propolis extract and a method for producing it to meet the needs mentioned above, eliminate all disadvantages, and provide additional advantages.

The main objective of the invention is to develop chocolate and such products with no added sugar as a sweetener, and a method for production of them for use in the food industry.

Another objective of the invention is to develop a product that has a longer shelf-life without the addition of any additives and preservatives using propolis extract in both inner and outer fillings of such products.

A further objective of the invention is to develop a product with improved nutritional properties by adding propolis extract that is rich in antioxidant and antifungal activities and a method for their production.

Another objective of the invention is to develop chocolate and similar products with no addition of sugar, additives, and preservatives as an alternative to chocolate products rich in sugar, fat, preservatives and various additives and a method for production of them.

Another objective of the invention is to provide consumable of product with the utilization of propolis extract which has a unique aroma in chocolate and similar products while developing new aroma and taste profiles.

A further objective of the invention is to develop chocolate and similar products added with honey and propolis extract without any negative impact on taste and shelf-life and a method for the production of such products.

For achieving all the above objectives, the invention is a chocolate or a similar food product consisting of raw honey as a sweetener and propolis extract in both inner and outer filling for use in the food industry.

For achieving all the above objectives, the invention is chocolate or a similar product production method, and it consists of the following steps of production;
i. Mixing the raw materials of cacao powder, cacao mass, and cacao fat until they become homogenous to obtain a chocolate mix,
ii. Thinning by grinding homogenous chocolate mixture,
iii. Subjecting chocolate mixture to conching process after thinning,
iv. Obtaining mixture with propolis thereby adding propolis extract after conching process,
v. Tempering the mixture with propolis,
vi. Obtaining outer filling by coating the molds with tempered propolis mixture,
vii. Cooling down the outer filling coated molds,
viii. Obtaining inner filling by pouring propolis extract-raw honey mixture prepared previously to the outer filling cooled on molds surface,
ix. Obtaining the final product by pouring chocolate mixture onto inner filling and,
x. Cooling the final product.

### DETAILED DESCRIPTION OF THE INVENTION

In this detailed description, chocolate consisting of propolis extract and its production method and the preferred ingredients and parameters have been disclosed solely for a better understanding of the subject and for not causing any restrictive effect.

The invention is a chocolate or a similar food product consisting of raw honey as sweetener and propolis extract in both inner and outer fillings as preservative for use in the food industry.

Table 1 presents the raw materials and ratios used in chocolate recipe consisting of added with propolis extract.

TABLE 1
Recipe of chocolate added with propolis extract

| | By weight quantities | Preferred quantity by |
|---|---|---|
| Raw material | that can be used (%) | weight (%) |
| Cacao Powder | 27.5 | 10-55 |
| Cacao Fat | 22.0 | 10-45 |
| Cacao Mass | 4.95 | 2-15 |
| Raw Honey | 44.3 | 10-60 |
| Propolis Extract | 1.25 | 1-30 |

An illustrative sample of the invention may consist of various components, in addition to the recipe given in Table 1, such as pistachio nuts, peanuts, walnuts, pollen, royal jelly, bee bread in addition to honey and propolis extract in the inner filling.

In another embodiment of the invention, in addition to the recipe given in Table 1, propolis extract added chocolate products may contain milk and natural aroma except for additives, preservatives, sweetener agent and sugar

Chocolate produced with the addition of raw honey and propolis extract based on the recipe given in Table 1 may be categorized as chocolate with no arefinedsugar and no preservative. One of the most significant advantages of the chocolate disclosed under this invention is that there is no need for crystalized sugar or an additional sweetener. The mentioned product contains raw honey as sweetener and propolis extract as a preservative.

Method for production of chocolate disclosed hereunder consists of four main processes in general: mixing, thinning, conching, and tempering. Propolis extract being subject of the present invention is used in both inner and outer filling to extend the shelf life of chocolate. Thus, shelf-life of the product can be increased up to 24 months.

Ingredients of 10-55% cacao powder, 10-45% cacao oil, and 2-15% cacao mass are mixed, and a homogenous chocolate mixture is obtained. Afterward, that homogenous mixture is thinned by grinding. Following mixing and thinning stages the mixture is taken into kneading tanks, called with conch, for conching process.

During the conching stage, the moisture of the mixture is reduced, aggregated particles are removed, and viscosity is adjusted. Taste and liquidity of chocolate during conching is increased. Conching process of the present invention is conducted in the ranges of 24-30 hour and 35-40° C. depending on the type and structure.

After the conching process step, 1-5% propolis extract by weight is added to the chocolate mixture and the outer filling mixture is obtained. The outer filling mixture is subjected to a tempering step for the prevention of the occurrence of unstable cacao oil crystals with a low melting point. The tempering process is conducted at a range of 26−32° C. for production of chocolate added with containing propolis.

The molds are coated with the outer filling mixture according to the desired size and shapes as the above step prevents the formation of unstable cacao oil crystals. The molds can be cooled down at 14-18° C. between a half and one hour.

The inner filling is obtained by pouring previously prepared propolis-raw honey mixture which is obtained adding 10-60% raw honey by weight and 5-30% propolis extract by weight onto the outer filling cooled on the mold's surface. The final product is obtained by pouring chocolate mixture onto the inner filling. The final product is cooled down at 14-18° C. for about a half and one hour. Following its cooling, the final product be packed according to the preferred packing method and stored.

Thus, the use of raw honey instead of refined sugar eliminates the need for additional sugar and sweeteners. Utilizing of propolis extract in both inner and outer filling portions also helps to extend the shelf-life of the product without any need for a food additive. Besides, the invention offers a choice for consumers who believe in natural products that are healthier than the products containing refined sugar and some other sweeteners.

1. A sweet food product, containing both inner filling and outer filling, for use in the food industry, and characterized that it is a chocolate or a similar product comprising raw honey as sweetener and propolis extract as a preservative in both inner and outer fillings.

2. A sweet food product according to claim 1, wherein the inner filling comprises propolis extract of 5-30% by weight.

3. A sweet food product according to claim 1, wherein the outer filling comprises a mixture of 10-60% raw honey (by weight) and 1-5% propolis extract by weight.

4. A sweet food product according to claim 1, comprising cacao powder, cacao oil, and cacao mass.

5. A sweet food product according to claim 1, comprising:
raw honey in the rates of 10-60% by weight; and
propolis extract in the rates of 1-30% by weight.

6. A sweet food product according to claim 1, comprising:
cacao powder in the rates of 10-55% by weight;
cacao oil in the rates of 10-45% by weight; and
cacao mass in the rates of 2-15% by weight.

7. A sweet food product according to claim 1, comprising:
cacao powder in the rates of 24-30% by weight;
cacao oil in the rates of 20-25% by weight;
cacao mass in the rates of 5-10% by weight;
raw honey in the rates of 45-60% by weight; and
propolis extract in the rates of 1-5% by weight.

8. A sweet food product according to claim 1, comprising pistachio nuts, peanuts or walnuts.

9. A sweet food product according to claim 1, comprising pollen, royal jelly, or bee bread.

10. A sweet food product according to claim 1, comprising milk.

11. A sweet food product according to claim 1, comprising natural aroma.

12. A method for production of a sweet food product comprising process steps of:
mixing the raw materials of cacao powder, cacao mass, and cacao fat until they become homogenous to obtain a chocolate mix;
thinning by grinding homogenous chocolate mixture;
subjecting chocolate mixture to conching process after thinning;
obtaining mixture with propolis thereby adding propolis extract after conching process;
tempering the mixture with propolis;
obtaining outer filling by coating the molds with tempered propolis mixture;
cooling down the outer filling coated molds;
obtaining inner filling by pouring propolis extract-raw honey mixture prepared previously to the outer filling cooled on molds surface;
obtaining the final product by pouring chocolate mixture onto inner filling and;
cooling the final product.

13. A sweet food product according to claim 9, wherein the conching process is conducted at 35-40° C. for 24-30 hours.

14. A sweet food product according to claim 1, wherein the tempering process is performed at a temperature range of 26-32° C.

15. A sweet food product according to claim 1, wherein the cooling down process is conducted at 14-18° C. for a half and 1 hour.
